(19) United States
(12) Patent Application Publication
(10) Pub. No.: US 2016/0008114 A1
(43) Pub. Date: Jan. 14, 2016

(54) DENTAL FLOSS HOLDER

(71) Applicant: Joseph A. Stofko, DMD, Gibsonia, PA (US)

(72) Inventor: Joseph A. Stofko, DMD, Gibsonia, PA (US)

(21) Appl. No.: 14/680,192

(22) Filed: Apr. 7, 2015

Related U.S. Application Data
(63) Continuation-in-part of application No. 29/438,280, filed on Nov. 28, 2012, now Pat. No. D726376.

(51) Int. Cl. A61C 15/04

(52) U.S. Cl. CPC A61C 15/046

(57) ABSTRACT

A one piece molded dental floss holder comprises an arcuate elongated handle terminating at a head at one distal end and a tapered pick end defined on an end of the handle opposite the head; a pair of spaced apart arms extending from the head, the spaced apart arms having a first end and a second end, the first end of the spaced apart arms adjoining the head of the handle; and a mushroom head floss element tie off on the top of the handle portion. The pair of spaced apart arms preferably includes visual operational references in the form of visible spiral grooves.

### RELATED APPLICATIONS

The present invention is a continuation in part of U.S. patent application Ser. No. 29/438,280 entitled “Dental Floss Holder” filed Nov. 28, 2012 and issued Apr. 7, 2015 as U.S. Pat. No. D726,376, which patent is incorporated herein by reference in its entirety.

### BACKGROUND OF THE INVENTION

1. Field of the Invention

This invention generally relates to Dental Floss Holders, also commonly called Dental Flossers.

2. Background Information

The history of dental floss is somewhat in question, but according to most sources, credit for the invention of dental floss goes to a New Orleans dentist, who in 1815 began advising his patients to use a thin silk thread to clean between their teeth (presumably the battle of New Orleans, also in 1815, garnered more press in the city at the time). Regardless, eventually the idea caught on, and in 1882 a company called the Codman and Shurtleft Company, based in Randolph, Mass., began marketing an unwaxed silk dental floss. This was followed in 1896 by the first dental floss from Johnson & Johnson. The New Jersey-based J&J took out a patent for dental floss in 1898 that was made from the same silk material used by doctors for silk stitches. During the 1940s, nylon replaced silk as the material for dental floss-its consistent texture and resistance to shredding were an improvement over the silk versions. The use of nylon also allowed for the development of waxed floss in the 1940s, and for the development of dental tape in the 1950s. Since then, the variety of types of dental floss has expanded to include newer materials such as Gore-Tex, and different textures such as spongy floss and soft floss. And today's floss has other features to make flossing easier. For example, floss with stiffened ends is designed to help with flossing around braces or other dental appliances. Today, floss is a key part of the recommended twice daily brushing, daily flossing, and regular use of a mouthwash that make up a healthy routine for maintaining one's oral health.

With the development of dental floss came the development of apparatus to hold the dental floss during use to assist the user. Expired utility U.S. Pat. Nos. 542,782, 2,444,638 , 5,113,880, 5,280,797, 5,692,531 and expired Design Pats. D237,186, D241,985, D274,375, D276,088, D279,826, D301,071, D301,172, D309,041, D316,617, D357,551, D382,367, D403,120, broadly discloses a dental floss holder including a elongated handle terminating at a head; a pair of spaced apart arms extending from the head, the spaced apart arms having a first end and a second end, the first end of the spaced apart arms adjoining the head of the handle; a length of dental floss configured to extend between the second end of the arms; and a tapered pick end defined on an end of the handle opposite the head. In these designs the arms are aligned generally along the axis of the handle, rather than perpendicular thereto, with the arm orientation representing a distinct class of device because of the distinct holding and manipulation pattern used by the user. These expired patents are incorporated herein by reference.

Expired Utility U.S. Pat. Nos. 918,281, 3,834,404, 4,041,962, 4,162,687 and Design Pats. D412,043 D424,748 disclose the history of a distinct class of dental flossers, namely these broadly disclose dental floss holders which include a elongated handle terminating at a head; a pair of spaced apart arms extending from the head, the spaced apart arms having a first end and a second end, the first end of the spaced apart arms adjoining the head of the handle; a length of dental floss configured to extend between the second end of the arms; and a tapered pick end defined on an end of the handle opposite the head. In these designs the arms are arranged in a spacing generally perpendicular to the longitudinal axis of the handle. These expired patents are incorporated herein by reference.

Regarding the more recent designs, U.S. Design Pats. D463,626, D481,829, D484,643, D531,757, D531,758, D532,160, D532,934, D545,499, D578,254, D609405, D610,748, D618,396, D624,703, D629,970, D649,713, each broadly discloses a dental floss holder including a elongated handle terminating at a head; a pair of spaced apart arms extending from the head, the spaced apart arms having a first end and a second end, the first end of the spaced apart arms adjoining the head of the handle; a length of dental floss configured to extend between the second end of the arms; and a tapered pick end defined on an end of the handle opposite the head. Utility U.S. Pat. No. 5,738,125 also broadly discloses a dental floss holder including a elongated handle terminating at a head; a pair of spaced apart arms extending from the head in line with the handle, the spaced apart arms having a first end and a second end, the first end of the spaced apart arms adjoining the head of the handle; a length of dental floss configured to extend between the second end of the arms; and a tapered pick end defined on an end of the handle opposite the head. The '125 patent teaches the advantage of very specific angles of 150-170 degrees between the handle and the arms because this angle is presumed to improve operation. Utility U.S. Pat. No. 5,704,379 also broadly discloses a dental floss holder including a elongated handle terminating at a head; a pair of spaced apart arms extending from the head in line with the handle, the spaced apart arms having a first end and a second end, the first end of the spaced apart arms adjoining the head of the handle; a length of dental floss configured to extend between the second end of the arms; and a tapered pick end defined on an end of the handle opposite the head. The '379 patent expresses the advantages of the linear frame design which maintains the elements in the same plane and further promotes some very specific angles, again to improve the effectiveness of the dental flosser. Utility U.S. Pat. No. 7,997,287 also broadly discloses a dental floss holder including a elongated handle terminating at a head; a pair of spaced apart arms extending from the head, the spaced apart arms having a first end and a second end, the first end of the spaced apart arms adjoining the head of the handle; a length of dental floss configured to extend between the second end of the arms; and a tapered pick end defined on an end of the handle opposite the head. The '287 patent expresses the advantages of integral tongue cleaning elements (“rugous cleaning surfaces”) on the handle and pick end. Utility U.S. Pat. No. 8,555,901 also broadly discloses a dental floss holder including a elongated handle terminating at a head; a pair of spaced apart arms extending from the head, the spaced apart arms having a first end and a second end, the first end of the spaced apart arms adjoining the head of the handle; a length of dental floss configured to extend between the second end of the arms; and a tapered pick end defined on an end of the handle opposite the head. The '901 patent provides an advantage of nestable handle designs for improved storage and shipping. The above patents are incorporated herein by reference.

From the above, somewhat comprehensive history, it is evident that a number of dental flossers have been proposed and that minor changes in the ergonomics and geometries can result in significant change in the manner of operation and effectiveness. It is important for the dental flosser to easily hold dental floss and for such to be easily gripped and used by the operator. Further it is important that these devices be inexpensive to manufacture and have an appealing design to the user. It is an object of the present invention to address the deficiencies of the prior art discussed above and to do so in an efficient, cost effective manner.

### SUMMARY OF THE INVENTION

The various embodiments and examples of the present invention as presented herein are understood to be illustrative of the present invention and not restrictive thereof and are non-limiting with respect to the scope of the invention.

In the practice of the present invention, there is provided an improved one piece molded dental floss holder comprises an arcuate elongated handle terminating at a head at one distal end and a tapered pick end defined on an end of the handle opposite the head; a pair of spaced apart arms extending from the head, the spaced apart arms having a first end and a second end, the first end of the spaced apart arms adjoining the head of the handle; and a mushroom head floss element tie off on the top of the handle portion. The pair of spaced apart arms preferably includes visual operational references in the form of visible spiral grooves.

These and other advantages of the present invention will be clarified in the description of the preferred embodiments taken together with the attached figures.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a bottom plan of a disposable, molded dental floss holder suited for users with braces with the holder extending from a pick end through the handle portion to spaced floss holding arms at the other end extending at an angle away from the handle and including spiral grooves as operational reminders thereon;

FIG. 2 is a left side elevation view of the dental floss holder of FIG. 1 wherein an mushroom head floss element tie off on the top of the handle portion is visible;

FIG. 3 is a left side elevation view of the dental floss holder of FIG. 1;

FIG. 4 is a top plan view of the dental floss holder of FIG. 1;

FIG. 5 is front elevation view of the dental floss holder of FIG. 1; and

FIG. 6 is a rear elevation view of the dental floss holder of FIG. 1.

### DESCRIPTION OF THE PREFERRED EMBODIMENTS

Generally the invention consists of a dental floss holder 10 comprising: an arcuate or curved elongated handle 12 terminating at a head 15 at one distal end and a tapered pick end 13 defined on an end of the handle 12 opposite the head 15; a pair of spaced apart arms 18 extending from the head, the spaced apart arms 18 having a first end and a second end, the first end of the spaced apart arms 18 adjoining the head 15 of the handle 12; and a mushroom head floss element tie off 16 on the top of the handle 12 portion. The dental floss holder 10 preferably provides wherein the pair of spaced apart arms 18 includes visual operational references 22 in the form of visible spiral grooves or indicia. Further each of the pair of spaced apart arms 18 includes a floss receiving notch 20 at a distal second end thereof. The arcuate elongated handle 12 includes a molded finger grip protrusion 14 on an underside thereof for improved ergonomics.

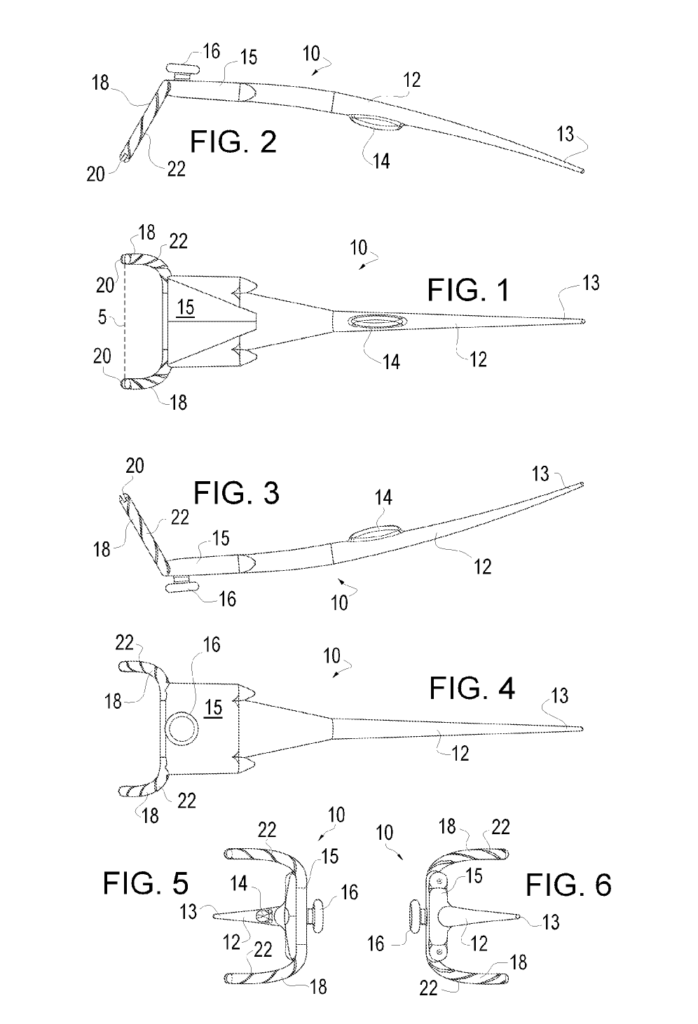

FIG. 1 is a bottom plan of a disposable, one piece molded dental floss holder 10 suited for users with braces illustrating the holder 10 extending from the tapered pick end 13 through the handle portion to spaced floss holding arms 18 at the other end extending at an angle away from the head 15 of the handle 12 and with the arms 18 including visual indicia in the form of visible spiral grooves 22 that serve as operational reminder thereon. The grooves 22 remind the user with braces of the motion for proper flossing operation. FIG. 2 is a left side elevation view of the dental floss holder 10 of FIG. 1 wherein the mushroom head floss element tie off 16 on the top of the handle 12 portion is visible. The floss 5 shown in FIG. 1 in phantom, is wrapped or looped around the element 16 and passed through the notches 20 at the distal second end of each arm 18 and back to the element 16. The operative space for the floss is between the arms 18 FIG. 3 is a left side elevation view of the dental floss holder 10 of FIG. 1; FIG. 4 is a top plan view of the dental floss holder 10 of FIG. 1; FIG. 5 is front elevation view of the dental floss holder 10 of FIG. 1; and FIG. 6 is a rear elevation view of the dental floss holder of FIG. 1.

The dental floss holder 10 is preferably a one piece molded article allowing the ergonomic holder to be inexpensively manufactured and formed as a disposable article. The dental floss holder includes the preferably arcuate elongated handle 12 which includes the molded finger grip protrusion 14 midway along its length on an underside thereof as shown. The dental floss holder 10 as shown provides wherein the tapered pick end 13 defined on an end of the handle 12 opposite the head 15 is substantially circular in cross section, and further the pick end 13 may include integral tongue cleaning elements (not shown) on the handle 12 and pick end 13.

The handle 12 is arcuate or curved down from a generally flat head 15 to the tapered pick end 13 for ease of gripping and use of both the flossing end and the tapered pick end. Further when placed with the bottom facing down the tapered pick end 13 of the arcuate handle 12 and the second distal ends of the arms 18 form a tripod support for the handle 12 making it easier for the user to grasp, with the notches 22 acting to generally hold the handle up in an easy to grasp position. Further the shape of the head 15 and the taper of the handle 12 toward the pick end 13 allow the dental floss holder 10 to be easily received in toothbrush receiving orifice often available in bathroom vanities and the like.

The dental floss holder as shown has the pair of spaced apart arms 18 extend along a plane and wherein the plane of the pair of spaced apart arms 18 is formed as an obtuse angle (generally about 125 to 175 degrees) relative to the underside of the head 15 of the handle 12. Further the dental floss holder is designed wherein each of the pair of spaced apart arms 18 includes the floss receiving notch 20 at a distal end thereof, as described above and, wherein each floss receiving notches 20 at the distal end of each pair of spaced apart arms 18 is positioned laterally wider than the head 15.

The holder 10 may be used by dentists and orthodontists as “promotional item” or product given away to clients, and potential clients, to aid in their oral hygiene. The top of the tie off element 16 and the head 15 will easily receive the Dentist identifying indicia, logo, business information (such as via a sticker or direct printing) to facilitate this practice. The inclusion of the orthodontist/dentist business information, (promotional branding) can facilitate the contacting of the orthodontist/dentist when needed and on a more regular basis.

The dental floss holder 10 of the invention maintains the advantages of the prior art flossers and further yields a dental floss holder 10 which easily holds dental floss and it is easily gripped and used by the operator, including a wide operational zone between the arms 18 (without being impractical) and user indicating indicia 22 to remind the user of desired motion. Further it is important that the dental floss holder 10 is inexpensive to manufacture and a design which is visibly appealing to the user. The Dental Floss holder 10 is an effective, user friendly, efficient, cost effective dental flosser.

While this invention has been particularly shown and described with references to preferred embodiments thereof, it will be understood by those skilled in the art that various changes in form and details may be made therein without departing from the scope of the invention encompassed by the appended claims.

What is claimed is:

1. A dental floss holder comprising:
a. An arcuate elongated handle terminating at a head at one distal end and a tapered pick end defined on an end of the handle opposite the head;
b. a pair of spaced apart arms extending from the head, the spaced apart arms having a first end and a second end, the first end of the spaced apart arms adjoining the head of the handle; and
c. a mushroom head floss element tie off on the top of the handle portion.

2. The dental floss holder as recited in claim 1, wherein the pair of spaced apart arms includes visual operational references in the form of visible spiral indicia.

3. The dental floss holder as recited in claim 2, wherein the dental floss holder is a one piece molded article.

4. The dental floss holder as recited in claim 3, wherein the arcuate elongated handle includes a molded finger grip protrusion on an underside thereof.

5. The dental floss holder as recited in claim 4, wherein pair of spaced apart arms extend along a plane.

6. The dental floss holder as recited in claim 5, wherein the plane of the pair of spaced apart arms is formed as an obtuse angle relative to the underside of the head of the handle.

7. The dental floss holder as recited in claim 6, wherein the tapered pick end defined on an end of the handle opposite the head is substantially circular in cross section.

8. The dental floss holder as recited in claim 7, wherein each of the pair of spaced apart arms includes a floss receiving notch at a distal end thereof.

9. The dental floss holder as recited in claim 8, wherein each floss receiving notches at the distal end of each pair of spaced apart arms is positioned laterally wider than the head.

10. A dental floss holder comprising:
a. An elongated handle terminating at a head at one distal end and a tapered pick end defined on an end of the handle opposite the head; and
b. a pair of spaced apart arms extending from the head, the spaced apart arms having a first end and a second end, the first end of the spaced apart arms adjoining the head of the handle wherein the pair of spaced apart arms includes visual operational references in the form of visible spiral indicia.

11. The dental floss holder as recited in claim 10, wherein each of the pair of spaced apart arms includes a floss receiving notch at a distal end thereof.

12. The dental floss holder as recited in claim 11, wherein each floss receiving notches at the distal end of each pair of spaced apart arms is positioned laterally wider than the head.

13. The dental floss holder as recited in claim 12, wherein the pair of spaced apart arms extend along a plane.

14. The dental floss holder as recited in claim 13, wherein the plane of the pair of spaced apart arms is formed as an obtuse angle relative to the underside of the head of the handle.

15. The dental floss holder as recited in claim 14, wherein the dental floss holder is a one piece molded article.

16. The dental floss holder as recited in claim 15, wherein the elongated handle includes a molded finger grip protrusion on an underside thereof.

17. The dental floss holder as recited in claim 16, further including a mushroom head floss element tie off on the top of the handle portion.

18. A dental floss holder comprising:
a. An elongated handle terminating at a head at one distal end;
b. a pair of spaced apart arms extending from the head, the spaced apart arms having a first end and a second end, the first end of the spaced apart arms adjoining the head of the handle, wherein the pair of spaced apart arms includes visual operational references in the form of visible spiral grooves; and
c. a mushroom head floss element tie off on the top of the handle portion.

19. The dental floss holder as recited in claim 18, wherein the pair of spaced apart arms extend along a plane, and each of the pair of spaced apart arms includes a floss receiving notch at a distal end thereof, wherein each floss receiving notches at the distal end of each pair of spaced apart arms is positioned laterally wider than the head.

20. The dental floss holder as recited in claim 19, wherein the plane of the pair of spaced apart arms is formed as an obtuse angle relative to the underside of the head of the handle, and wherein a tapered pick end is defined on an end of the handle opposite the head.
